(19) United States
(12) Patent Application Publication
(10) Pub. No.: US 2018/0355983 A1
(43) Pub. Date: Dec. 13, 2018

(54) DIAPHRAGM VALVE

(71) Applicant: CKD CORPORATION, Komaki-shi (JP)

(72) Inventors: Tatsushi NABEI, Komaki-shi (JP); Yukie NAKAMURA, Komaki-shi (JP); Sayumi TAKANO, Komaki-shi (JP)

(21) Appl. No.: 16/102,754

(22) Filed: Aug. 14, 2018

Related U.S. Application Data
(63) Continuation of application No. PCT/JP2017/004513, filed on Feb. 8, 2017.

(30) Foreign Application Priority Data
Feb. 18, 2016 (JP) 2016-029400

(51) Int. Cl. F16K 7/17

(52) U.S. Cl. CPC F16K 7/17; F16K 15/148

(57) ABSTRACT

A diaphragm valve includes a first valve housing, a diaphragm, a drive member, and a second valve housing. The diaphragm has a second abutting surface opposed to a first abutting surface, and a sealing portion formed on a position surrounding a second abutting surface. The diaphragm has an elastic coupling portion that elastically deforms and couples the second abutting surface to the sealing portion to cause the second abutting surface to move to a side of the first valve housing with respect to the sealing portion. The elastic coupling portion has a concave curved surface having a curved surface shape that is concave to a side of the second valve housing. The second valve housing has a supporting portion having a second convex curved surface having a curved surface shape that is convex to a side of the elastic coupling portion on a position opposed to the concave curved surface.

### TECHNICAL FIELD

The present invention relates to a diaphragm, and especially relates to a diaphragm valve that performs a supply control of a high-pressure fluid.

### BACKGROUND ART

A diaphragm valve is used as a valve that controls a distribution of a chemical solution such as a photoresist solution. The diaphragm valve is a valve that uses a diaphragm that is a flexible film. The diaphragm valve functions using an elastic deformation of the flexible film. Thus, there has been a problem of a deterioration in durability caused by an excessive elastic deformation in a control of a high-pressure fluid. Specifically, there has been a problem that a part of the diaphragm permanently deforms (extends) caused by the control of the high-pressure fluid. For such a problem, a technique that supports a deformation portion of a diaphragm with a backup has been proposed (for example, JP-A-2011-237039, JP-A-2010-164130, and JP-A-2006-189117).

### DISCLOSURE OF THE INVENTION

### Problems to be Solved by the Invention

However, the inventors have reviewed a substantive cause of the permanent deformation of the diaphragm to contrive a form to transform the deformation of the diaphragm caused by a high fluid pressure into a flow of load and stress. Thus, the present inventors have succeeded in largely expanding a pressure range as a controlled object of the diaphragm valve to a high-pressure side.

The present invention has been made in view of the above-described circumstances, and it is an object of the present invention to provide a technique that expands a pressure range as a controlled object of a diaphragm valve to a high-pressure side.

### Solutions to the Problems

The present invention provides a diaphragm valve. This diaphragm valve includes a first valve housing, a diaphragm, a drive member, and a second valve housing. The first valve housing has a first flow passage opening, a first abutting surface formed on a position surrounding a peripheral area of the opening, and an annular concave portion formed on a position surrounding a peripheral area of the first abutting surface. The diaphragm has a second abutting surface opposed to the first abutting surface, and a sealing portion formed on a position surrounding the second abutting surface. The drive member is arranged on an opposite side of the first abutting surface with respect to the diaphragm. The drive member presses the diaphragm from the opposite side to cause the second abutting surface to abut on the first abutting surface to close the opening. The second valve housing is movably holds the drive member in a direction of a pressing. The second valve housing sandwiches the sealing portion with the first valve housing to seal a flow passage space communicable with the opening. The diaphragm has an elastic coupling portion that elastically deforms and couples the second abutting surface to the sealing portion to cause the second abutting surface to move to a side of the first valve housing with respect to the sealing portion. The elastic coupling portion has a concave curved surface having a curved surface shape that is concave to a side of the second valve housing. The second valve housing has a supporting portion having a second convex curved surface having a curved surface shape that is convex to a side of the elastic coupling portion on a position opposed to the concave curved surface.

The above-described diaphragm valve may have a shape where the first abutting surface has an outer diameter that is 40% or more of an outer diameter of the annular concave portion, and the opening has a port diameter that is 20% or less of the outer diameter of the annular concave portion.

In the above-described diaphragm valve, the second convex curved surface may have an outer diameter smaller than the outer diameter of the annular concave portion.

In the above-described diaphragm valve, the elastic coupling portion may have a first convex curved surface having a curved surface shape that is convex to the first valve housing side, and the first convex curved surface may have a curved surface shape that is convex to the first valve housing side in a region where a second clearance occurs between the concave curved surface and the second convex curved surface while the valve is open.

In the above-described diaphragm valve, the second clearance may have a large clearance on a side of the drive member compared with a side of the sealing portion.

In the above-described diaphragm valve, the diaphragm may be made of a PTFE.

### Effects of the Invention

The diaphragm valve of the present invention can expand the pressure range as the controlled object of the diaphragm valve to the high-pressure side.

### BRIEF DESCRIPTION OF THE DRAWINGS

FIG. 1 is a partial cross-sectional view illustrating a partial cross section of a diaphragm valve 10 according to one embodiment of the present invention.

FIG. 2 is an exploded view illustrating an exploded configuration of the diaphragm valve 10 according to the one embodiment.

FIGS. 3A and 3B include cross-sectional views illustrating states of an open-close operation of a valve mechanism portion 100 according to the one embodiment.

FIGS. 4A and 4B include cross-sectional views illustrating deformation states of an elastic coupling portion 114 according to the one embodiment.

FIG. 5 is a cross-sectional view illustrating a deformation state of the elastic coupling portion 114 according to the one embodiment.

FIG. 6 is a graph conceptually illustrating a relationship between a displacement of an actuator rod 410 according to the one embodiment and a load of a chemical solution.

FIGS. 7A and 7B include cross-sectional views illustrating stress states of the elastic coupling portion 114 according to the one embodiment.

FIGS. 8A and 8B include cross-sectional views illustrating stress states of the elastic coupling portion 114 according to the one embodiment.

FIGS. 9A and 9B include cross-sectional views illustrating states of an open-close operation of a valve mechanism portion according to a modification.

### DESCRIPTION OF PREFERRED EMBODIMENTS

The following describes a configuration for implementing the present invention (hereinafter referred to as “embodiment”) with reference to the drawings in the following order.

A. Configuration of Diaphragm Valve

B. Operation of Diaphragm Valve

C. Deformation State and Drive Load of Diaphragm

D. Stress State of Diaphragm

E. Modification

### A. Configuration and Operation of Diaphragm Valve

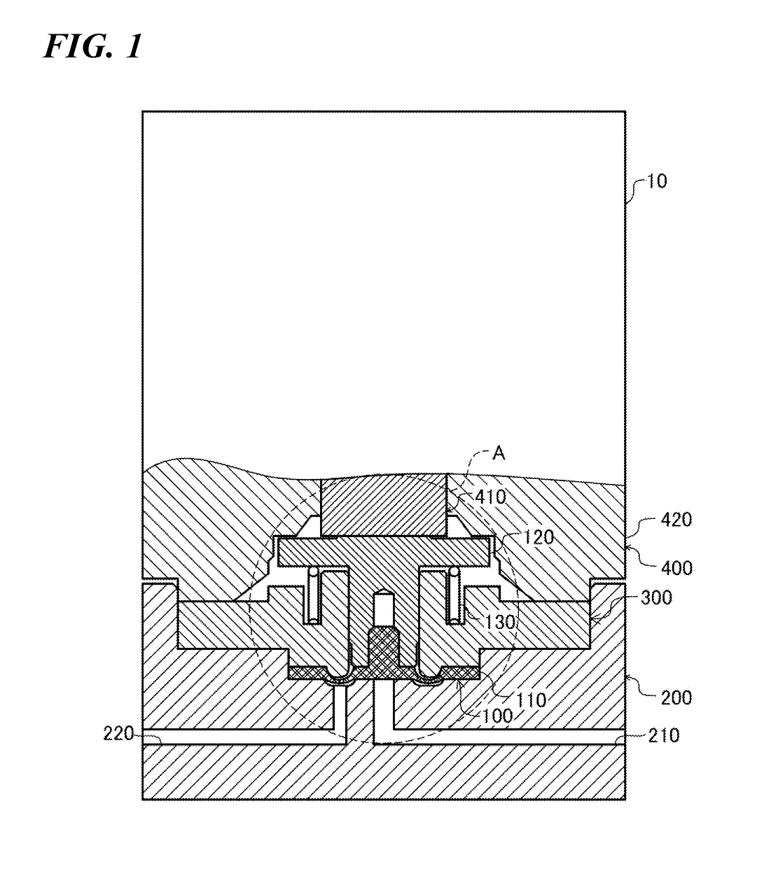

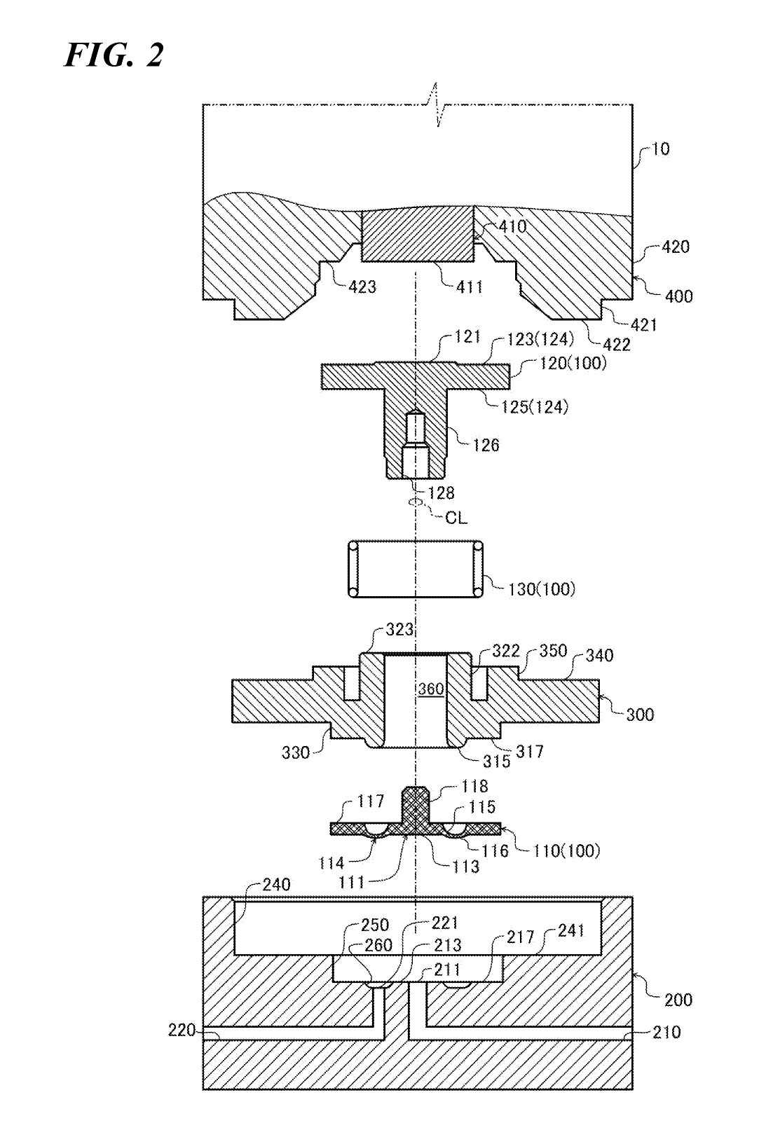

FIG. 1 is a partial cross-sectional view illustrating a partial cross section of a diaphragm valve 10 according to one embodiment of the present invention. FIG. 2 is an exploded view illustrating an exploded configuration of the diaphragm valve 10 according to the one embodiment. The diaphragm valve 10 performs an on-off control of a supply of a chemical solution as one example in this embodiment. In the diaphragm valve that performs the on-off control of the supply of the chemical solution, it has been conventionally assumed that a supply control of a fluid pressure up to around 500 kPa is generally a limit according to a specification. However, this embodiment ensures a control of the fluid pressure having around several MPa.

The diaphragm valve 10 includes a valve mechanism portion 100, a base housing 200 (also referred to as a first valve housing), a top housing 300 (also referred to as a second valve housing), and an actuator 400. The valve mechanism portion 100 includes a diaphragm valve element 110, a drive member 120, and a biasing portion 130.

The base housing 200 has an inlet-side flow passage 210 (also referred to as a first flow passage) and an outlet-side flow passage 220 (also referred to as a second flow passage). The diaphragm valve 10 is configured to perform the on-off control on a flow of the chemical solution from the inlet-side flow passage 210 to the outlet-side flow passage 220 by driving of the valve mechanism portion 100.

The base housing 200 is made of polyetheretherketone (PEEK) that is a resin having a chemical resistance since the inlet-side flow passage 210 and the outlet-side flow passage 220 through which the chemical solution passes are formed on the base housing 200. The polyetheretherketone has a very high heat resistance as a thermoplastic resin, and is excellent in properties such as an abrasion resistance, a dimensional stability, a fatigue resistance, and a workability.

The base housing 200 has a columnar outer shape. The base housing 200 internally has a first columnar concave portion 240 to store the top housing 300. The first columnar concave portion 240 has a housing-holding abutting surface 241 to hold the base housing 200. The first columnar concave portion 240 further has a second columnar concave portion 250 on a bottom surface.

The second columnar concave portion 250 has an inlet opening 211 (also simply referred to as an opening) of the inlet-side flow passage 210 on a central axis position. An annular abutting surface 213 (also referred to as a first abutting surface) that is an annular plane is formed on a position surrounding a peripheral area of the inlet opening 211. An annular concave portion 260 that is an annular concave portion is formed on a position surrounding a peripheral area of the annular abutting surface 213. A valve-element holding surface 217 that is an annular plane is formed on a position surrounding a peripheral area of the annular concave portion 260. An outlet opening 221 of the outlet-side flow passage 220 is formed on the annular concave portion 260.

The annular abutting surface 213 preferably has an outer diameter that is 40% or more of an outer diameter (a radius R1) of the annular concave portion 260 in order to reduce a permanent deformation caused by an excessive stress by abutting of a valve-element abutting surface 113. The opening 211 preferably has a port diameter (a diameter of an end portion on a side of the first abutting surface 213) that is 20% or less of an outer diameter of the annular concave portion 260. The outer diameter of the first abutting surface 213 is more preferably 46% or more of the outer diameter of the annular concave portion 260. The opening (211) preferably has further a shape with a port diameter that is 13% or less of the outer diameter of the annular concave portion 260.

The diaphragm valve element 110 can be formed, for example, by performing a cutting work on a polytetrafluoroethylene (PTFE) that is a fluororesin having a flexibility. The polytetrafluoroethylene is a material that is excellent in the heat resistance and the chemical resistance and does not melt into a hydrofluoric acid having a high corrosivity. The polytetrafluoroethylene further has a property that a friction coefficient is extremely small.

The diaphragm valve element 110 includes a valve element plate 111 having a disc shape on a center axis position. The valve element plate 111 has the valve-element abutting surface 113 (also referred to as a second abutting surface) that is a plane that abuts on the annular abutting surface 213 when the valve is closed. The valve-element abutting surface 113 is away from the annular abutting surface 213 when the valve is open to form a clearance space as a flow passage. A thread engagement portion 118 is coupled to the valve element plate 111. The drive member 120 described later is threadably mounted on the thread engagement portion 118.

An annular sealing portion 117 that is a plate member having an annular shape is formed on an outer periphery position of the diaphragm valve element 110. The annular sealing portion 117 abuts on the valve-element holding surface 217 of the base housing 200 to seal a flow passage part communicated with the outlet opening 221. The annular sealing portion 117 has a convex arch-shaped cross section on a side of the base housing 200, and is coupled to the valve element plate 111 via an elastic coupling portion 114 having an annular shape. The elastic coupling portion 114 has an arch-shaped cross-sectional shape having a convex curved surface 116 (also referred to as a first convex curved surface) having a curved surface shape that is convex to a side opposed to the annular concave portion 260, and having a concave curved surface 115 having a curved surface shape that is concave to its opposite side.

The top housing 300 is fabricated by, for example, machining a stainless steel. The top housing 300 has a top-housing main body 340 having a disc shape. The top-housing main body 340 has an annular convex portion 330 having an annular shape projecting to a side of the diaphragm valve element 110. A supporting portion having a convex annular shape on the diaphragm valve element 110 side and having an annular support surface 315 (also referred to as a second convex curved surface) having a convex curved surface is formed on a center side of the annular convex portion 330. A through hole 360 is formed inside the annular support surface 315.

The top housing 300 has an annular convex portion 350 having an annular shape projecting to a side opposed to the diaphragm valve element 110. A cylindrically-shaped groove 322 to store the biasing portion 130 (for example, a coil spring) is formed inside the annular convex portion 350.

The drive member 120 is fabricated by, for example, machining a stainless steel. The drive member 120 has a drive shaft portion 126 having a columnar shape, and a flange portion 124 having a disc shape coupled to the drive shaft portion 126. The flange portion 124 has a biasing-portion abutting surface 125 on which the biasing portion 130 abuts, on a side of the top housing 300. The flange portion 124 further has a valve-opening-stroke specifying surface 123 that is an annular-shaped plane to specify a drive stroke in a valve opening direction of the actuator 400, on a side of the actuator 400.

In the drive member 120, a drive abutting surface 121 that receives a driving force from the actuator 400 is formed inside the valve-opening-stroke specifying surface 123. A thread engagement hole 128 on which the thread engagement portion 118 is threadably mounted is formed on a central axis position of the drive shaft portion 126.

The valve mechanism portion 100 is configured by attaching the diaphragm valve element 110, the drive member 120, and the biasing portion 130 to the top housing 300. First, the biasing portion 130 is attached to the top housing 300. The biasing portion 130 is stored in the groove 322.

Next, the drive shaft portion 126 of the drive member 120 is inserted into the through hole 360 of the top housing 300. In the through hole 360, a grease is applied to a slider with the drive member 120 in order to ensure a smooth operation of the drive shaft portion 126. Instead of applying of the grease, a bush may be equipped. When the drive shaft portion 126 is inserted, the biasing portion 130 stored in the groove 322 of the top housing 300 abuts on the biasing-portion abutting surface 125 of the flange portion 124 of the drive member 120.

The drive shaft portion 126 is further inserted to be fixed to a jig (not illustrated) in a state where the flange portion 124 has abutted on an abutting surface 323 to make a state where the thread engagement hole 128 projects from the through hole 360 of the top housing 300. The thread engagement portion 118 of the diaphragm valve element 110 is threadably mounted on the thread engagement hole 128.

This assembles the valve mechanism portion 100 on the top housing 300, thus constituting a valve mechanism assembly 100, 300. In the valve mechanism assemblies 100, 300, the drive member 120 is attached movably in a pressing direction of the diaphragm valve element 110 to be kept.

Thus, the drive member 120 is disposed on an opposite side of the annular abutting surface 213 with respect to the diaphragm valve element 110. The drive member 120 presses the diaphragm valve element 110 from the opposite side to cause the valve-element abutting surface 113 to abut on the annular abutting surface 213, thus closing the inlet opening 211.

The valve mechanism assembly 100, 300 are attached to the base housing 200 as below. The diaphragm valve element 110 and the annular convex portion 330 are stored in the second columnar concave portion 250 of the base housing 200. The top-housing main body 340 is stored in the first columnar concave portion 240 of the base housing 200 (see FIG. 1).

The annular sealing portion 117 of the diaphragm valve element 110 is held by the valve-element holding surface 217 of the base housing 200 and the annular convex portion 330. A position of the top housing 300 with respect to the base housing 200 is specified by the housing-holding abutting surface 241. This specifies a difference between a sum of a thickness of the annular sealing portion 117 and a height of the annular convex portion 330, and a depth of the second columnar concave portion 250 as a compression deformation amount of the annular sealing portion 117.

The actuator 400 includes an actuator rod 410 and an actuator housing 420. The actuator rod 410 is driven to be reciprocated in an axial direction with respect to the actuator housing 420. Its driving method may be a method to drive the actuator rod 410 with, for example, an electromagnetic force or a fluid pressure. The actuator rod 410 has a driving abutting surface 411 to transmit the driving force to the drive member 120 via the drive abutting surface 121.

The actuator housing 420 has an annular convex portion 421 as an annular convex portion having a shape fitted to the first columnar concave portion 240 of the base housing 200. The annular convex portion 421 has a datum-reference abutting surface 422 as a plane opposed to the top housing 300 side. The datum-reference abutting surface 422 abuts on the top-housing main body 340 to specify a position in the axial direction of the actuator 400 with respect to the top housing 300. The actuator housing 420 further has a stroke-reference abutting surface 423 that abuts on the valve-opening-stroke specifying surface 123 to specify the valve-open state.

The actuator 400 is fitted to the first columnar concave portion 240 to be fastened with a fastening member (for example, a bolt) (not illustrated) in a state where the datum-reference abutting surface 422 abuts on the top-housing main body 340 to hold the valve mechanism assembly 100, 300 between the actuator 400 and the base housing 200. Thus, the diaphragm valve 10 can be assembled.

### B. Operation of Diaphragm Valve

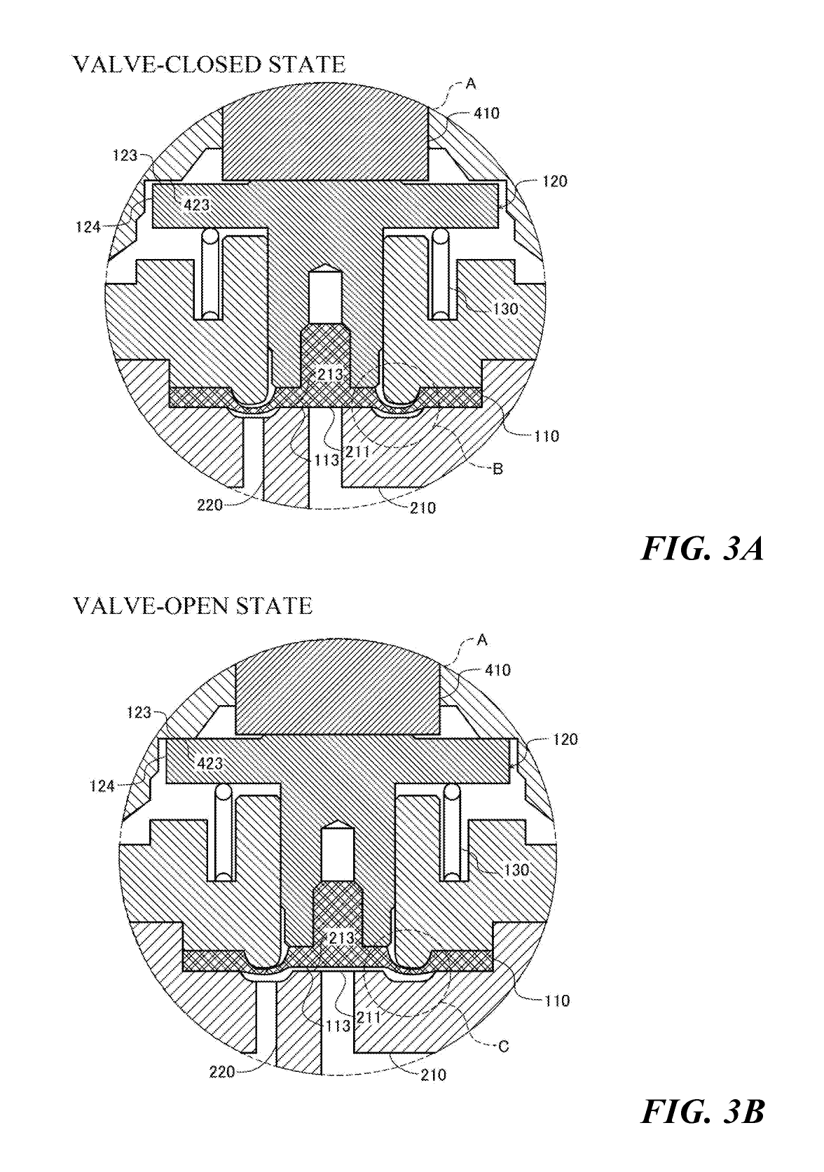

FIGS. 3A and 3B include cross-sectional views illustrating states of an open-close operation of the valve mechanism portion 100 according to the one embodiment. FIG. 3A illustrates a valve-closed state of the valve mechanism portion 100. FIG. 3B illustrates a valve-open state of the valve mechanism portion 100. In the valve-closed state, the inlet opening 211 of the inlet-side flow passage 210 is closed such that the valve-element abutting surface 113 of the diaphragm valve element 110 abuts on the annular abutting surface 213 of the base housing 200, thus being separated from the outlet-side flow passage 220. In the valve-open state, the inlet-side flow passage 210 is communicated with the outlet-side flow passage 220 via a flow passage space formed between the valve-element abutting surface 113 and the annular abutting surface 213.

In the valve-closed state, the actuator 400 moves the actuator rod 410 to the base housing 200 side to press the diaphragm valve element 110 via the drive member 120. The valve-element abutting surface 113 of the diaphragm valve element 110 receives a fluid pressure on a side of the actuator 400 in the inlet opening 211 and receives an abutting pressure from the annular abutting surface 213 of the base housing 200. The abutting pressure is a pressure generated as a reaction of a load from the actuator rod 410 to close and seal the inlet opening 211.

In a transition from the valve-closed state to the valve-open state, the actuator 400 zeros (or reduces) a driving load of the actuator rod 410. The drive member 120 starts moving the actuator rod 410 to the actuator 400 side with a biasing load of the biasing portion 130, the fluid pressure in the inlet opening 211, and a load caused by the abutting pressure from the annular abutting surface 213.

When the valve-element abutting surface 113 separates from the annular abutting surface 213, the drive member 120 receives a load caused by a fluid pressure of the chemical solution that has flowed into the flow passage space of a clearance (also referred to as a first clearance) between the valve-element abutting surface 113 and the annular abutting surface 213, instead of the abutting pressure from the annular abutting surface 213. The drive member 120 moves until its valve-opening-stroke specifying surface 123 abuts on the stroke-reference abutting surface 423 of the actuator housing 420, and stops corresponding to this abutting. In the valve-open state, such a state will be maintained.

In the transition from the valve-open state to the valve-closed state, the actuator 400 turns on the driving load of the actuator rod 410. The drive member 120 moves the valve-element abutting surface 113 of the diaphragm valve element 110 to a side of the annular abutting surface 213 against the biasing load of the biasing portion 130 and the fluid pressure received by the diaphragm valve element 110, and causes the valve-element abutting surface 113 to abut on the annular abutting surface 213 to close and seal the inlet opening 211. In the valve-closed state, such a state will be maintained.

### C. Deformation State and Drive Load of Diaphragm

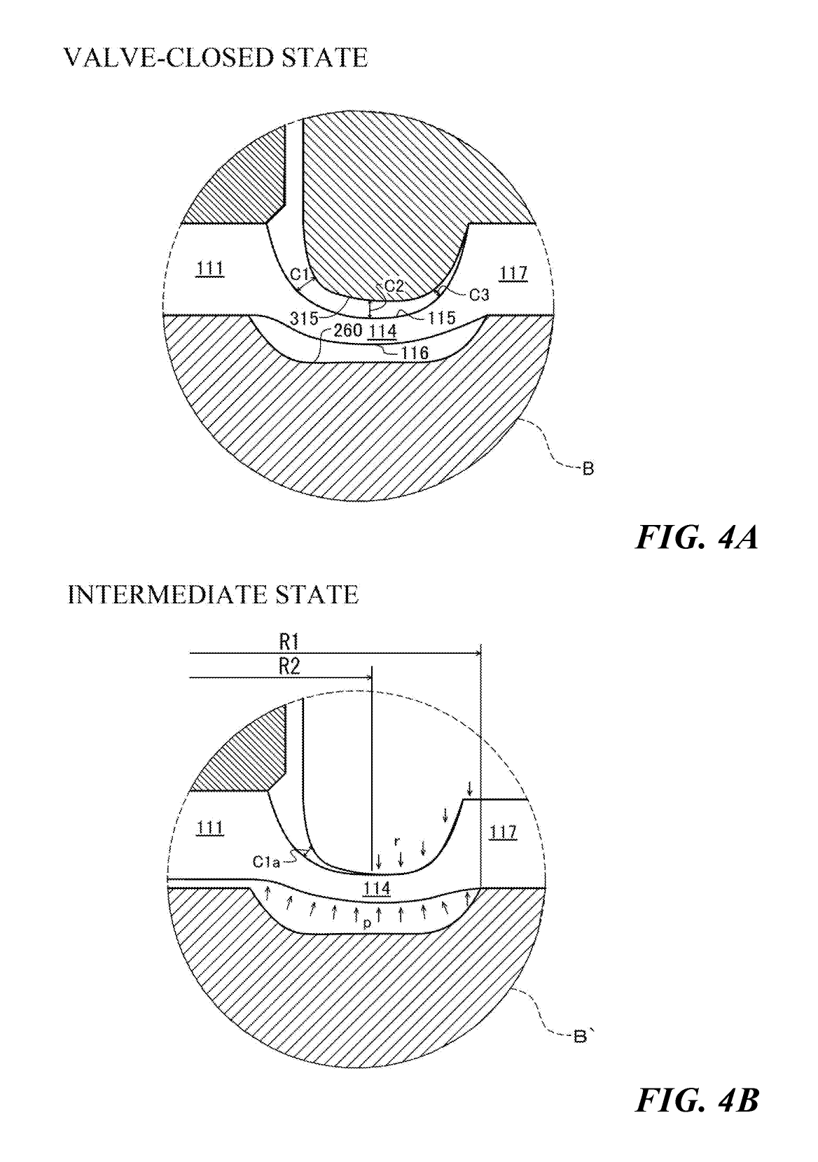

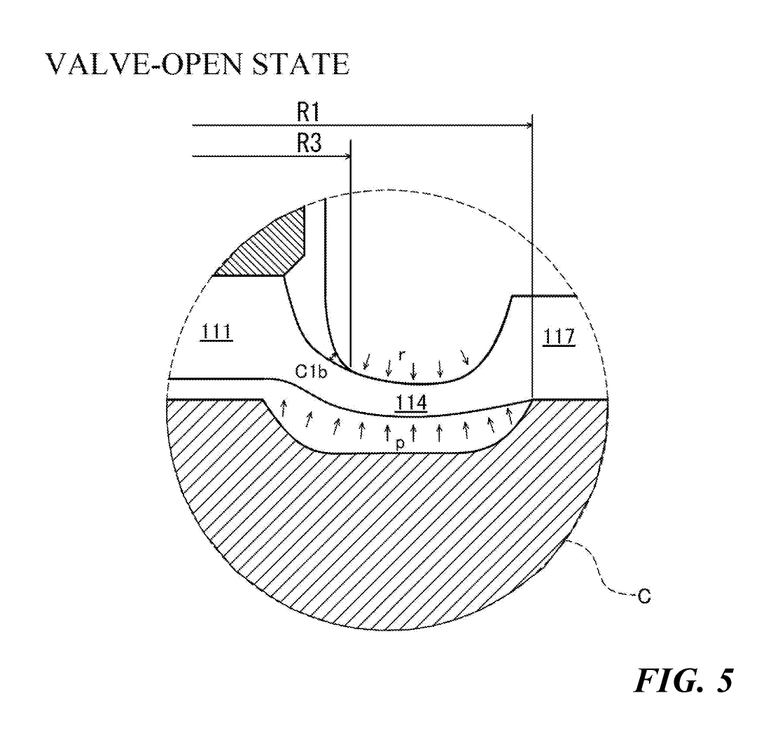

FIGS. 4A and 4B and FIG. 5 are cross-sectional views illustrating deformation states of the elastic coupling portion 114 according to the one embodiment. FIG. 4A illustrates a deformation state of the elastic coupling portion 114 in the valve-closed state. The elastic coupling portion 114 has clearances C1 to C3 with the annular support surface 315 in the valve-closed state. The clearances C1 to C3 are provided to deform the elastic coupling portion 114 in order to ensure a move to the actuator 400 side of the valve element plate 111. For the clearances C1 to C3, the clearance C1 on a side close to the valve element plate 111 is large, and the clearance C3 on a side apart from the valve element plate 111 is small. The clearance C2 between the clearance C1 and the clearance C3 has their intermediate size. The clearances C1 to C3 are also referred to as second clearances.

The annular support surface 315 has a convex curved surface having a curved surface with relatively small curvatures at the proximity of the valve element plate 111 and at the proximity of the annular sealing portion 117 and a relatively large curvature at an intermediate region between them. The annular support surface 315 can employ a convex curved surface having a cross-sectional shape with various curved surfaces such as a shape where a plurality of circles having mutually different cycloids and curvatures are combined, corresponding to various specifications such as a usage and a fluid pressure of the diaphragm valve 10.

FIG. 4B illustrates a deformation state of the elastic coupling portion 114 in an intermediate state. The intermediate state is an intermediate state between the valve-closed state and the valve-open state. The elastic coupling portion 114 has a clearance C1a with the annular support surface 315 in the intermediate state. The clearance C1a is a clearance on a position of the clearance C1 in the valve-closed state. At positions of the clearances C2 and C3, the clearances vanish, and the elastic coupling portion 114 is in a state supported by the abutting on the annular support surface 315.

The elastic coupling portion 114 receives a bearing force from the annular support surface 315 in regions of the clearances C2 and C3 while receiving a pressure p of the chemical solution in the intermediate state. The bearing force occurs as a drag (a pressure r) as a reaction against the pressure p of the chemical solution. The drag (the pressure r) as the reaction occurs in an annular region that has removes a circle with a radius R2 from a circle with the radius R1. Meanwhile, a load of the actuator rod 410 caused by the pressure r occurs in the circle with the radius R1 that receives the pressure p of the chemical solution.

The radius R1 is a distance from a center position of the diaphragm valve element 110 to a boundary position where the annular sealing portion 117 abuts on the annular concave portion 260. The radius R2 and the radius R3 are distances from the center position of the diaphragm valve element 110 to boundary positions where the elastic coupling portion 114 abuts on the annular support surface 315.

In the elastic coupling portion 114, in the valve-open state, an area that receives the pressure p of the chemical solution does not change, but a range that receives the bearing force from the annular support surface 315 has expanded. That is, the drag (the pressure r) as the reaction occurs in an annular region that has removed a circle with a radius R3 (the radius R3<the radius R2) from the circle with the radius R1. The elastic coupling portion 114 has a clearance C1b, which is further smaller than the clearance C1a with the annular support surface 315 in the valve-open state. The clearance C1b is a clearance on the position of the clearance C1 in the valve-closed state.

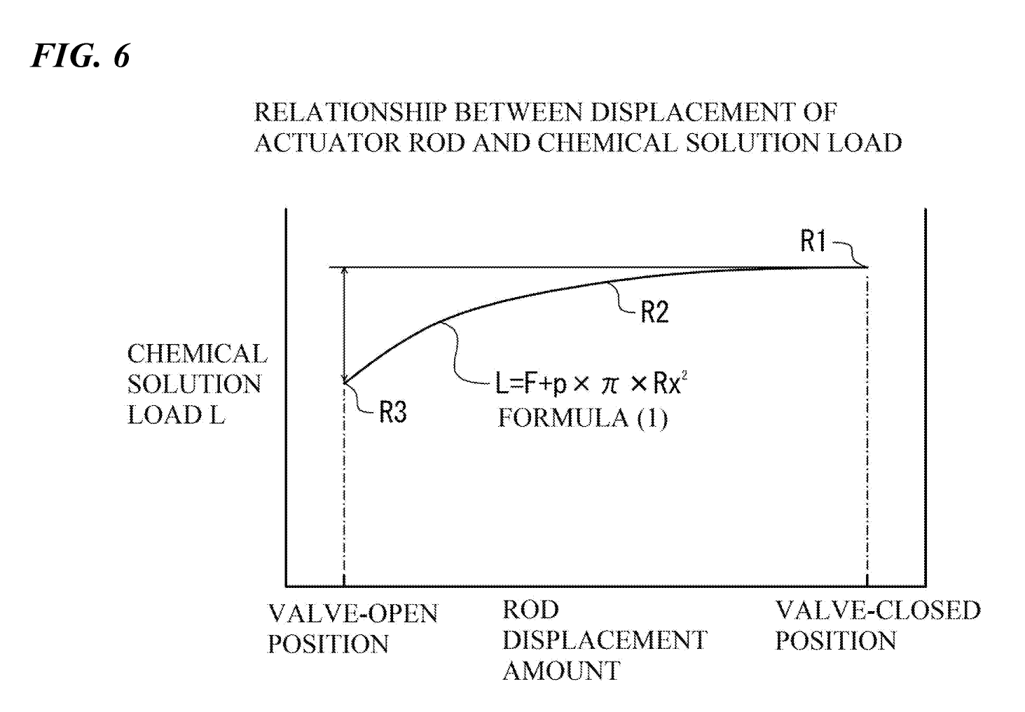

FIG. 6 is a graph conceptually illustrating a relationship between the displacement of the actuator rod 410 according to the one embodiment and the load of the chemical solution. Its horizontal axis indicates a rod displacement amount, and its vertical axis indicates a chemical solution load L. The rod displacement amount is a displacement amount of the actuator rod 410, that is, a movement amount of the valve element plate 111 of the diaphragm valve element 110. The chemical solution load L is a load received from the chemical solution by the actuator rod 410.

The chemical solution load L is conceptually a load represented by a formula (1) in FIG. 6. In the formula (1), the load F is a variation load (the amount of variation is slight corresponding to the stroke) by the biasing portion 130, the pressure p is a pressure of the chemical solution, and Rx is a distance (for example, R2 and R3) from the center position of the diaphragm valve element 110 to the boundary position where the elastic coupling portion 114 abuts on the annular support surface 315.

It is understood that the chemical solution load decreases as the rod displacement amount approaches an amount equivalent to a position close to a valve-open position. It is because a pressurized area of the pressure r as the drag from the annular support surface 315 increases as the rod displacement amount approaches the valve-open position. This can diminish an acceleration to a direction of the valve-open position of the valve element plate 111 at the time of the valve-opening operation to decrease an impact while the valve is open (while the valve-opening-stroke specifying surface 123 is abutting on the stroke-reference abutting surface 423).

This impact causes a water hammer phenomenon (a rapid rise in pressure) where a quantity of motion of the flow of the chemical solution is transformed into the pressure. Accordingly, this configuration will be able to diminish the water hammer phenomenon while the valve is open. Furthermore, in this configuration, the elastic coupling portion 114 is supported by the annular support surface 315 at many parts while the valve is open. Thus, also in this respect, this configuration can reduce a damage of the elastic coupling portion 114 caused by the water hammer phenomenon.

### D. Stress State of Diaphragm

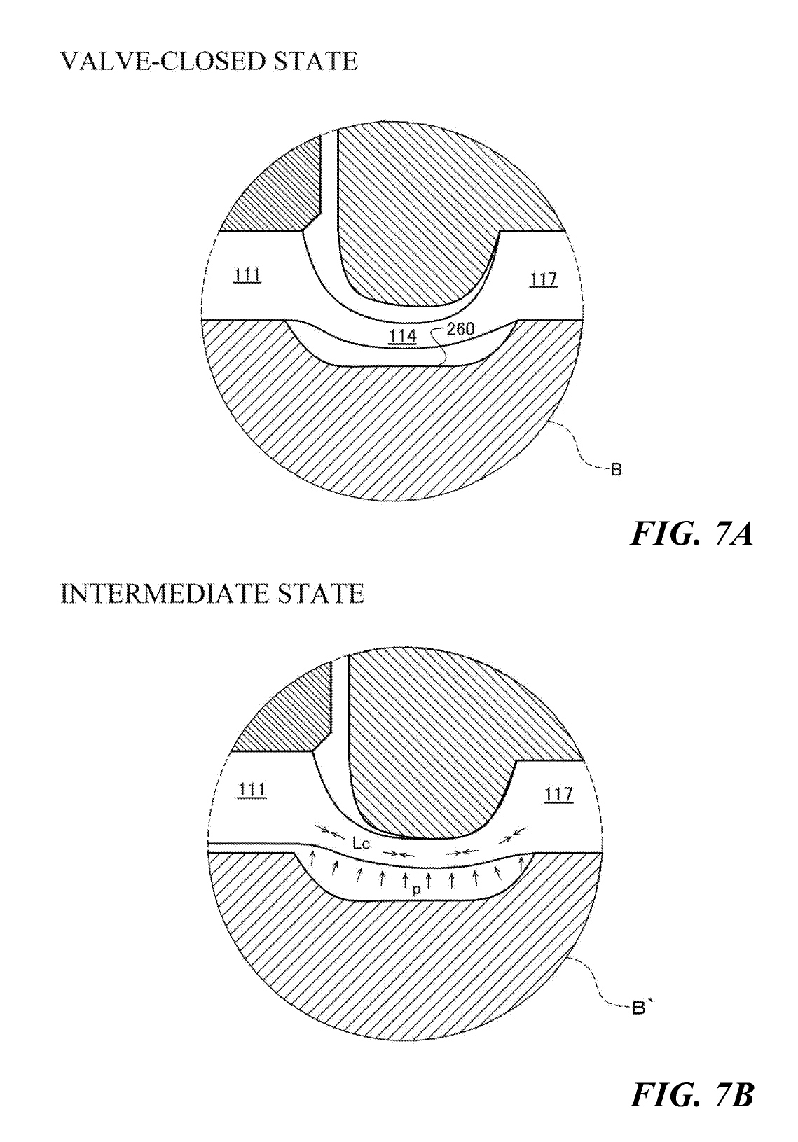

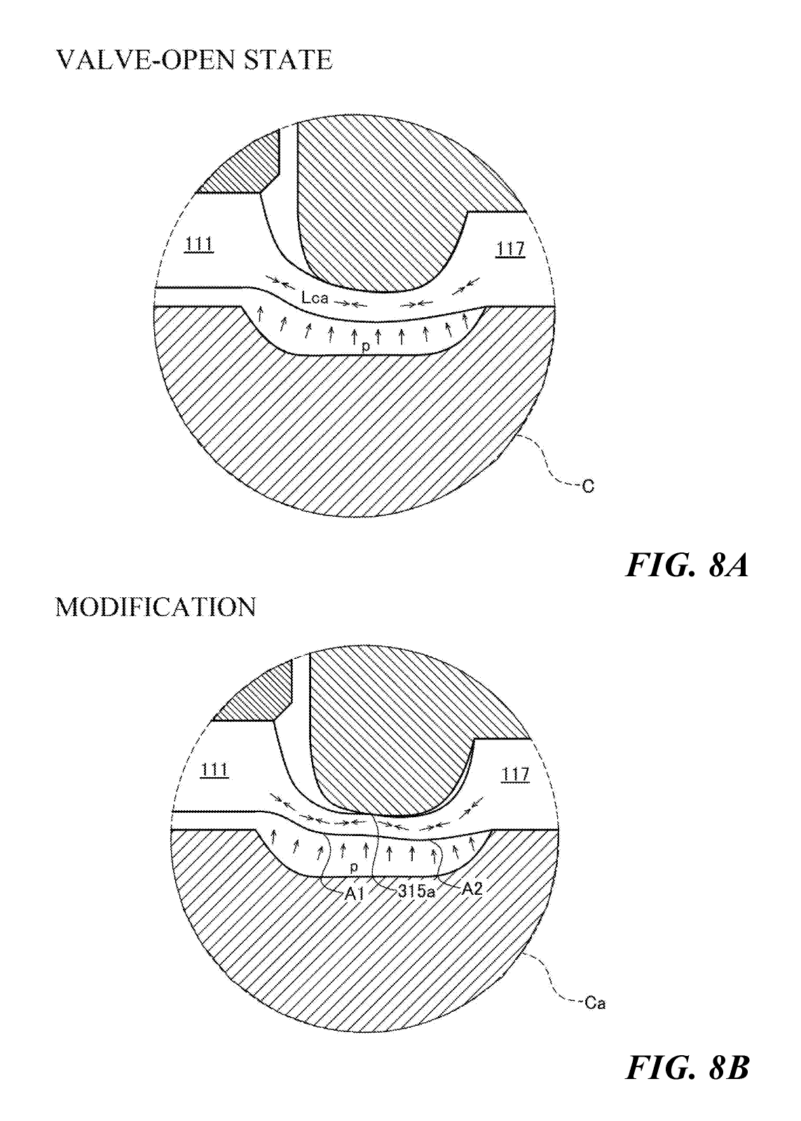

FIGS. 7A and 7B and FIGS. 8A and 8B are cross-sectional views illustrating stress states of the elastic coupling portion 114 according to the one embodiment. FIG. 7A illustrates a stress state of the elastic coupling portion 114 in the valve-closed state. The elastic coupling portion 114 is in a state receiving a back-pressure of the outlet-side flow passage 220 communicated with the annular concave portion 260 in the valve-closed state.

FIG. 7B illustrates a stress state of the elastic coupling portion 114 in the intermediate state. The elastic coupling portion 114 is in a state receiving the pressure p of a high-pressure chemical solution from the inlet-side flow passage 210 via the flow passage in the clearance between the valve-element abutting surface 113 and the annular abutting surface 213 in the intermediate state. The elastic coupling portion 114 has a convex curved surface having a convex curved surface shape projecting to the base housing 200 side and has an arch shape. Furthermore, the elastic coupling portion 114 has a shape whose thickness dimension gently increases from an apex of the convex curved surface or a vicinity of the apex toward a side of the drive member 120 and the sealing portion 117.

Thus, the pressure p of the chemical solution will generate a compressive stress Lc not a tensile stress in the elastic coupling portion 114. The compressive stress Lc is generated by the pressure p received in an arch-shaped region where a clearance resides between the elastic coupling portion 114 and the annular support surface 315. Meanwhile, the compressive stress Lc does not occur in a region where the elastic coupling portion 114 abuts on the annular support surface 315 without the clearance.

FIG. 8A illustrates a stress state of the elastic coupling portion 114 in the valve-open state. The elastic coupling portion 114 receives the support by the annular support surface 315 in a region wider than that in the intermediate state, in the valve-open state. Thus, the compressive stress Lca is also small.

Thus, in the diaphragm valve 10 according to the embodiment, the valve element plate 111 of the diaphragm valve element 110 can move by the elastic deformation of the elastic coupling portion 114. The elastic coupling portion 114 is supported by the annular support surface 315 at the time of the elastic deformation at least from the intermediate state to the valve-open state. This can decrease the deformation amount of the elastic coupling portion 114 caused by the high pressure of the chemical solution in the valve-opening operation. As a result, the diaphragm valve 10 ensures a distribution control of the chemical solution having a high fluid pressure with about several MPa.

### D. Modification

The present invention can be performed also in the following modification not only in the above-described embodiment.

Modification 1:

In the above-described embodiment, the elastic coupling portion 114 has the large clearance C1 on the side close to the valve element plate 111 and the small clearance on the side apart from the valve element plate 111, with the annular support surface 315. However, the elastic coupling portion 114 may have, for example, an approximately constant clearance, not limited to such clearances.

Modification 2:

In the above-described embodiment, the elastic coupling portion 114 deforms such that the abutting part on the annular support surface 315 expands from the side apart from the valve element plate 111. However, the present invention is not limited to such a deformation form. Specifically, for example, as a modification illustrated in FIG. 8B, a plurality of (two pieces in this modification) arch-shaped arch portions A1 and A2 may be formed to generate a clearance on the side apart from the valve element plate 111.

In this case, the arch portion A1 is supported by an arch support region 315a of the annular support surface 315 and the valve element plate 111 to generate a compressive stress inside the elastic coupling portion 114 corresponding to the fluid pressure received in a region between them. Meanwhile, the arch portion A2 is supported by the arch support region 315a of the annular support surface 315 and the annular sealing portion 117 to generate a compressive stress inside the elastic coupling portion 114 corresponding to the fluid pressure received in a region between them. The arch portion A1 and the arch portion A2 each have a region that receives the fluid pressure having a small arch, and are supported by the valve element plate 111 and the annular sealing portion 117. Thus, even if such a deformation occurs, the arch portion A1 and the arch portion A2 do not generate an excessive stress caused by the pressure p of the chemical solution.

In the transition between the valve-closed state and the valve-open state, the elastic coupling portion 114 and the annular support surface 315 may be configured so as to generate a movement (a slip) of the arch support region 315a. The region of the annular support surface 315 may have a configuration that fits, for example, an annular component made of polytetrafluoroethylene into the top housing 300 to improve a slipperiness with the elastic coupling portion 114. A deformable elastic material may be held between the elastic coupling portion 114 and the annular support surface 315.

Modification 3:

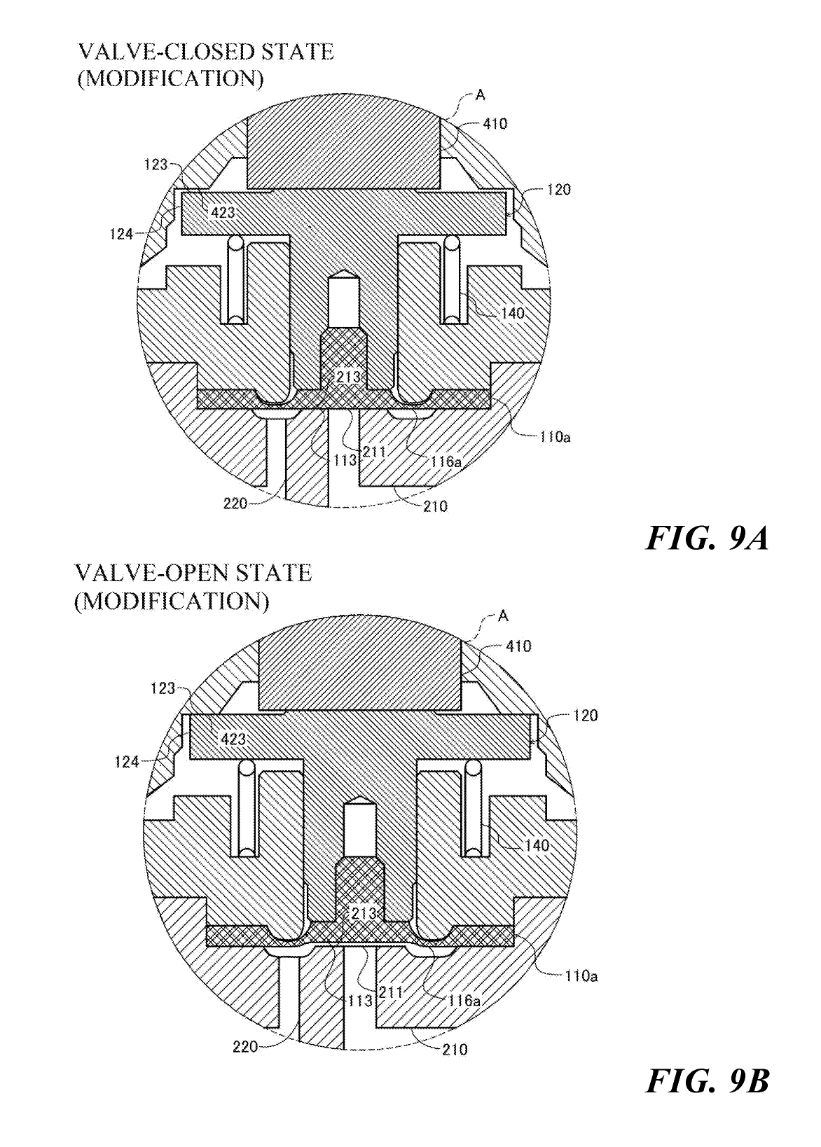

In the diaphragm valve element 110 in the above-described embodiment, the convex curved surface 116 having the curved surface that is convex on the side opposed to the annular concave portion 260 is formed on the elastic coupling portion 114. However, it is not necessarily to be the convex curved surface. Specifically, as illustrated in FIGS. 9A and 9B as a modification, for example, the elastic coupling portion may be configured to have a planar shape 116a continue into the valve-element abutting surface 113 while the valve is closed.

Modification 4:

In the above-described embodiment, the diaphragm valve 10 is used for the on-off control of the chemical solution. However, the diaphragm valve 10 can be used for another control such as a flow rate control not limited to the on-off control.

Modification 5:

In the above-described embodiment, the diaphragm valve 10 is the valve used for the supply of the chemical solution. However, it is not limited to this. The present invention is widely generally applicable to a valve that uses the diaphragm.

This application claims priority from Japanese Patent Application No. 2016-029400 filed with the Japanese Patent Office on Feb. 18, 2016, and the entire contents of which are hereby incorporated by reference.

The above description of a specific embodiment of the present invention is disclosed as illustrative. This does not intend to be exhaustive or limit the present invention to the described embodiments as they are. Many modifications and variations will be apparent to one of ordinary skill in the art in light of the above teachings.

### DESCRIPTION OF REFERENCE SIGNS

10: Diaphragm valve
100: Valve mechanism portion
110: Diaphragm valve element
114: Elastic coupling portion
115: Concave curved surface
116: Convex curved surface
117: Annular sealing portion
120: Drive member
130: Biasing portion
200: Base housing
211: Inlet opening
213: Annular abutting surface
300: Top housing
400: Actuator

What is claimed is:

1. A diaphragm valve comprising:
a first valve housing having a first flow passage opening, a first abutting surface formed on a position surrounding a peripheral area of the opening, and an annular concave portion formed on a position surrounding a peripheral area of the first abutting surface;
a diaphragm having a second abutting surface opposed to the first abutting surface, and a sealing portion formed on a position surrounding the second abutting surface;
a drive member arranged on an opposite side of the first abutting surface with respect to the diaphragm, the drive member pressing the diaphragm from the opposite side to cause the second abutting surface to abut on the first abutting surface to close the opening; and
a second valve housing that movably holds the drive member in a direction of a pressing, the second valve housing sandwiching the sealing portion with the first valve housing to seal a flow passage space communicable with the opening; wherein
the diaphragm has an elastic coupling portion that elastically deforms and couples the second abutting surface to the sealing portion to cause the second abutting surface to move to a side of the first valve housing with respect to the sealing portion,
the elastic coupling portion has a concave curved surface having a curved surface shape that is concave to a side of the second valve housing, and
the second valve housing has a supporting portion having a second convex curved surface having a curved surface shape that is convex to a side of the elastic coupling portion on a position opposed to the concave curved surface.

2. The diaphragm valve according to claim 1, wherein the first abutting surface has an outer diameter that is 40% or more of an outer diameter of the annular concave portion, and the opening has a port diameter that is 20% or less of the outer diameter of the annular concave portion.

3. The diaphragm valve according to claim 1, wherein the second convex curved surface has an outer diameter smaller than the outer diameter of the annular concave portion.

4. The diaphragm valve according to claim 2, wherein the second convex curved surface has an outer diameter smaller than the outer diameter of the annular concave portion.

5. The diaphragm valve according to claim 1, wherein:
the elastic coupling portion has a first convex curved surface having a curved surface shape that is convex to the first valve housing side; and
the first convex curved surface has a curved surface shape that is convex to the first valve housing side in a region where a second clearance occurs between the concave curved surface and the second convex curved surface while the valve is open.

6. The diaphragm valve according to claim 2, wherein:
the elastic coupling portion has a first convex curved surface having a curved surface shape that is convex to the first valve housing side; and
the first convex curved surface has a curved surface shape that is convex to the first valve housing side in a region where a second clearance occurs between the concave curved surface and the second convex curved surface while the valve is open.

7. The diaphragm valve according to claim 5, wherein the second clearance has a large clearance on a side of the drive member compared with a side of the sealing portion.

8. The diaphragm valve according to claim 6, wherein the second clearance has a large clearance on a side of the drive member compared with a side of the sealing portion.

9. The diaphragm valve according to claim 5, wherein:
the second convex curved surface has an outer diameter smaller than the outer diameter of the annular concave portion; and
the second clearance has a large clearance on a side of the drive member compared with a side of the sealing portion.

10. The diaphragm valve according to claim 6, wherein:
the second convex curved surface has an outer diameter smaller than the outer diameter of the annular concave portion; and
the second clearance has a large clearance on a side of the drive member compared with a side of the sealing portion.

11. The diaphragm valve according to claim 1, wherein the diaphragm is made of a PTFE.

12. The diaphragm valve according to claim 2, wherein the diaphragm is made of a PTFE.

13. The diaphragm valve according to claim 9, wherein the diaphragm is made of a PTFE.

14. The diaphragm valve according to claim 10, wherein the diaphragm is made of a PTFE.
